(19) United States
(12) Patent Application Publication
(10) Pub. No.: US 2021/0156755 A1
(43) Pub. Date: May 27, 2021

(54) INTERACTIVE KINETIC SENSING DEVICES AND SYSTEMS

(71) Applicants: James Andrew LESKOSEK, Summerland (CA); Shawn Robert DESAUTELS, Salmon Arm (CA)

(72) Inventors: James Andrew LESKOSEK, Summerland (CA); Shawn Robert DESAUTELS, Salmon Arm (CA)

(21) Appl. No.: 16/696,840

(22) Filed: Nov. 26, 2019

(51) Int. Cl. G01L 5/00; G01L 1/16; G01D 9/00

(52) U.S. Cl. CPC G01L 5/0052; G01D 9/00; G01L 1/16

(57) ABSTRACT

A kinetic sensing device is provided, the device including a) one or more sensor units, each sensor unit comprising one or more interactive light displays and one or more sensors in the form of voltage generating materials affixed under each interactive light display; b) a micro-controller for processing data from the one or more sensors; c) a transmitter for transmitting processed data from the micro-controller; and d) a power source for charging the sensors, powering the micro-controller and powering the transmitter. The sensors can detect and distinctly process each kinetic force reading and be set to zero to ready to process a next impact, in the absence of any capacitor. A method is also provided for sensing, processing and transmitting kinetic force data.

### FIELD

The present disclosure relates to devices and systems for collecting, interpreting and transmitting force related data. In one, non-limiting example the force data can be related to physical exercise, weight training and combat training.

### BACKGROUND

Physical training, sports training and weight training is increasingly sophisticated today. The use of sensors and monitors can provide more and more accurate data on an athlete's performance while training.

In combat related sports like boxing, martial arts and ultimate fighting (UFC) it is often desirable to track an athlete's punching or kicking performance. This could include an athlete's impact force, speed, aim while punching or kicking.

There are known devices that track some of this data. For example punching bags have been developed with accelerometers built into them and some form of display to provide force feedback. Such devices are expensive and the data is limited to the particular “smart” punching bag. While force data is sensed by such a device, other types of performance parameters such a speed and accuracy are not. Furthermore, there is no means of transmitting the data anywhere else and there is no means of data collection or tracking.

Piezoelectric sensor circuits are used in some instances for detecting pressure or contact. However these sensor circuits require additional piece and namely capacitors in order to store and discharge charge between kinetic force readings.

A need therefore exists in the art for devices and systems that can be used with a variety of exercise and training equipment for force and other parameter sensing. A need also exists for means for transmitting the resulting data, collecting it and tracking it for physical training purposes.

### SUMMARY

A kinetic sensing device is provided, the device including a) one or more sensor units, each sensor unit comprising one or more interactive light displays and one or more sensors in the form of voltage generating materials affixed under each interactive light display; b) a micro-controller for processing data from the one or more sensors; c) a transmitter for transmitting processed data from the micro-controller; and d) a power source for charging the sensors, powering the micro-controller and powering the transmitter. The sensors can detect and distinctly process each kinetic force reading and be set to zero to ready to process a next impact, in the absence of any capacitor. A method is also provided for sensing, processing and transmitting kinetic force data.

The method includes the steps of:
a) charging a sensor in the form of a voltage generating material, causing molecules in the voltage generating material to contract and simultaneously starting a cycle count;
b) performing a count of the oscillations before a charge or discharge has passed;
c) detecting a force;
d) discharging the sensor;
e) readying the sensor for a next kinetic force reading or interpretation; and
f) rapidly cycling back to step a).

It is to be understood that other aspects of the present disclosure will become readily apparent to those skilled in the art from the following detailed description, wherein various embodiments of the disclosure are shown and described by way of illustration. As will be realized, the disclosure is capable of other and different embodiments and its several details are capable of modification in various other respects, all without departing from the spirit and scope of the present disclosure. Accordingly the drawings and detailed description are to be regarded as illustrative in nature and not as restrictive.

### BRIEF DESCRIPTION OF THE DRAWINGS

A further, detailed, description of the disclosure, briefly described above, will follow by reference to the following drawings of specific embodiments of the disclosure. The drawings depict only typical embodiments of the disclosure and are therefore not to be considered limiting of its scope. In the drawings:

FIG. 1 is a front view of a modular kinetic sensing system of the present disclosure;

FIG. 2 is a partial cross sectional, perspective view of a kinetic sensing device of the present disclosure;

FIG. 3A is a front view of three interactive light display pieces positioned on a punching bag;

FIG. 3B is a side view of the punching bag of FIG. 3A; and

FIG. 4 is a photograph of a kinetic sensing system of the present disclosure, showing one configuration of set up.

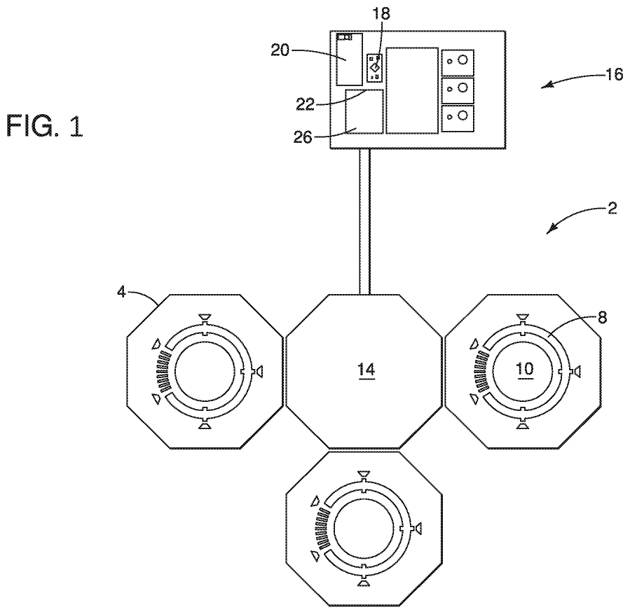

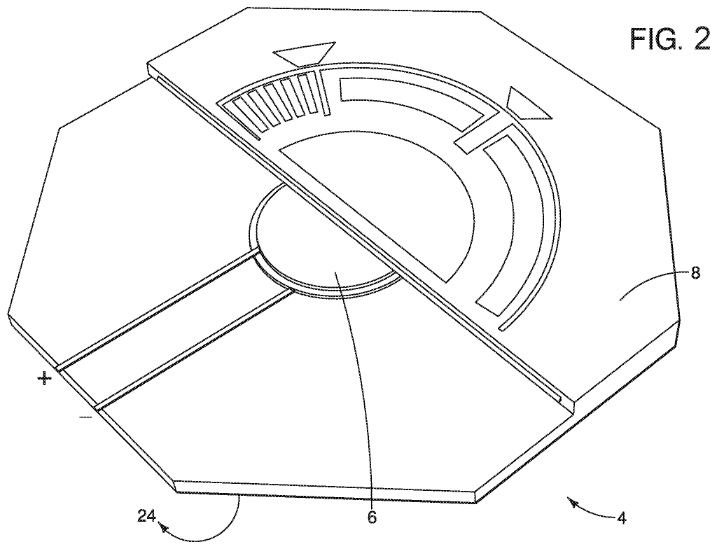

The drawings are not necessarily to scale and in some instances proportions may have been exaggerated in order to more clearly depict certain features.

### DETAILED DESCRIPTION

The description that follows and the embodiments described therein are provided by way of illustration of an example, or examples, of particular embodiments of the principles of various aspects of the present disclosure. These examples are provided for the purposes of explanation, and not of limitation, of those principles and of the disclosure in its various aspects.

The present disclosure relates to a kinetic smart device that is attachable to any number of apparatus for physical training or exercise, safety equipment and personal protective equipment such as hard hats, helmets and others.

When attached thereto, the present device can collect data from the exercise apparatus and processes the data in real time to provide feedback in the form of force or other training related parameters. The device also can send and receive data via a wireless communication and is designed to interact with smart devices such as smart phones, tables and personal computers via an application. Data processing can be done entirely at the device in the micro-controller, in the application on the smart device, or at a combination of both.

With reference the Figures the present devices and systems 2 comprise one or more sensor units 4, each comprising one or more sensors 6 distributed therein. Each sensor unit 4 further comprises an interactive display 8 on a first surface, the interactive light display providing an athlete with a target aim 10 for either punching or kicking. In one form the interactive display 8 can take the form of a lighted unit showing a target 10. The sensor units 4 are flexible. In a preferred embodiment a flexible and at least somewhat yielding layer may be applied over the interactive display layer 8, to provide minor cushioning to a user at impact. In a further preferred embodiment, the partially yielding layer may be made from silicon rubber.

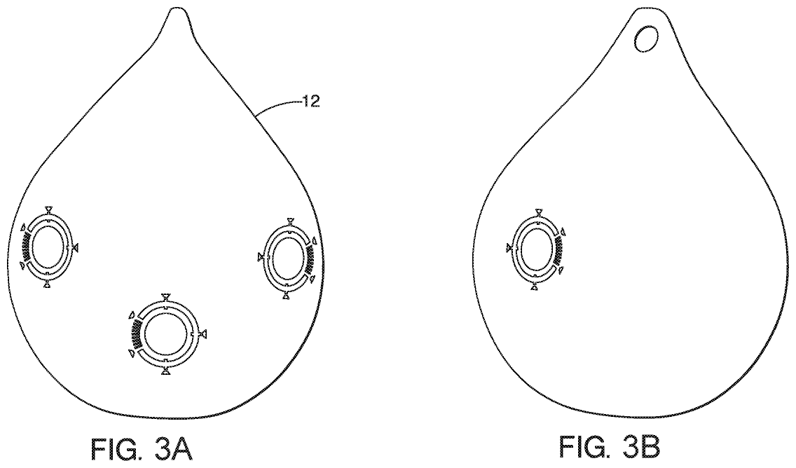

While the present devices and systems 2 can be used with any number of types of applications, for the purposes of ease of illustration, use of the present devices and systems with a punching bag 12, such as that shown in FIG. 3, is referred to herein.

The sensor units 4 can be connected to one another to form a modular system 2, and the arrangement of the modular system 2 can vary depending on the exercise or training equipment that the modular system is affixed to. In some embodiments, a connection hub 14 in the form of an attachable, not non-sensory element can be used to connect wiring between the various sensors 6 and also to connect the sensor units 4 and modular system 2 to a microcontroller unit 16. However, a connection hub 14 is not always necessary and sensor units 4 can be directly connected and wired to one another and to the microcontroller unit 16 without a connection hub 14.

The microcontroller unit 16 can be arranged such that there is one per modular system 2 or there could be more than one microcontroller unit 16 per modular system 2. It is also possible for individual microcontroller units 16 to be housed in each sensor unit 4, in cases where only one sensor unit 4 is used.

The microcontroller unit 16 houses the microcontroller 18. The microcontroller unit also houses a power source 20 in the form of one or more batteries, to power the microcontroller 18, to power a wireless transmitter 22 and provide a charge used by the sensor 6. The wireless transmitter 22 is optionally external to and connectable to the microcontroller unit 16 and, more preferably is imbedded within the microcontroller unit 16. In some embodiments, optionally, one or more relays 26 may be provided in the micro-controller unit 16 to control which signals come from which sensor units 4. In this way, reverberation, jostling or other ‘noise’ from sensor units not in use do not create a fase signal to the microcontroller 18.

The sensor units 4 are most preferably flexible; most preferably printed on flexible printed circuits (FPCs) .The attachable sensor units 4 can be removed and replaced in the modular system 2 if damaged. In some embodiments, the device's microcontroller unit 16 is not internal but connected to a flexible flat cable (FFC) ribbon that is set at a distance from the kinetic sensor units 4 and flexible interactive display layer 8, in a separate enclosure.

The sensor 6 is preferably comprised of a voltage generating material embedded in each sensor unit 4. The voltage generating material can be a piezo-electric or a carbon nano-tube material, and is more preferably a piezo electric material.

The present sensors 6 provide a unique sensing method. Data from each impact (a hit, punch, kick, step etc.) can be distinctly processed and then the processing system can be set to zero to then be ready to process a next impact, without the need for a traditional capacitor in the circuit. First, a controlled charge from the power source 20 via the micro-controller 18 is used to stabilize the voltage generating material, causing the molecules in the voltage generating material to contract, and then the microcontroller starts a cycle count. The present sensors 6 provide real-time rapid charge and discharge, and can handle a large range of force data; hence no time is needed to discharge the sensors 6 to be ready for the next kinetic force reading or interpretation. The sensor design eliminates the need for capacitors and the sensors 6 can be directly connected to the micro-controller 18 without the need for an intermediary capacitor. In addition to simplifying the design in this way, capacitors have limited ranges of force they can handle and need to be set. The present sensors 6 allow for a greater kinetic force range of detection. The microcontroller 18 does a count of the oscillations (timing cycles) before a charge (or discharge) has passed through a circuit comprising the power source/microcontroller/sensor. A cycle of recorded time, typically measured as several milliseconds is equivalent to a particular weight/force of impact. In recording the cycle, a curve is formed—either a spike curve in the case of a rapid impact or a more gradual curve for slower impact—the microcontroller 18 interprets the tip of the spike or top of the curve as the final force data.

When the circuit is zeroed, the sensor 6 is cleared of any original force data and from any charge going through it, ready to record the next kinetic force reading. In this way, the present sensors 6 continually cycle through these steps. The cycle is extremely fast, in the range MHz, or about a million cycles per second, allowing for a rapid sample rate.

As described earlier, and as illustrated in the figures, a flexible interactive light display layer 8 is formed as a separate layer in front of the sensor layer and is used for visual interaction such as targets for impact, reaction times, kinetic energy applied and appearance purposes. In a preferred embodiment, the type of light used in the flexible, interactive display layer 8 can be a flexible electroluminescent light.

The attachable backing 24 of the sensing unit can be any known attachable, affixable or adhesive backing, capable of being applied to and removed from the exercise or training equipment. In a preferred embodiment, a silicone rubber sticker was used as the backing 24.

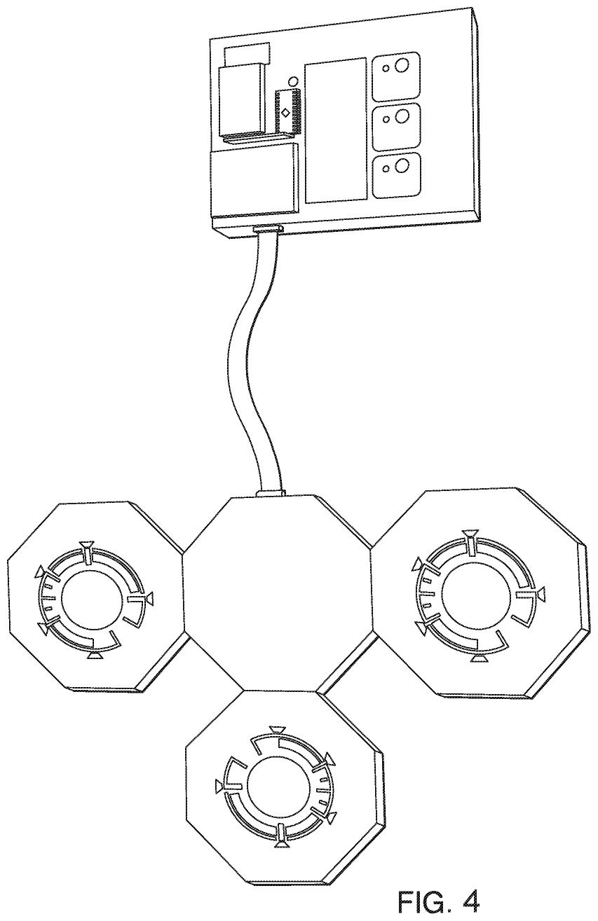

In the examples shown in FIG. 4, a piezo electric disc as the sensor 6 is placed behind a light display layer 8 to form each sensor unit 4. Three sensor units 4 are attached to a center hub 14 to form the sensor modular system 2 and the sensor module system 2 is applied by a sticker back layer 24 to a punching bag. An FFC ribbon extends from the sensor modular system 2 to another adhesive microcontroller unit 16 that contains the microcontroller 18 and power source power supply 20. Relays switch the lighting for the interactive display 8. In one preferred embodiment, a WX ESP8266 Wi-Fi module is used as a wireless transmitter 22. Data can be sent wirelessly to a smartphone, tablet or computer for displaying and also optionally storing and tracking kinetic energy, reaction time, speed, rhythm and aim data. The application on a smart device can be used to determine what data is shown and in what format. The application, and also optionally the micro-controller 18 may include interactive controls and functions to apply a training regime, in the form of a pattern of lights to be displayed on the interactive light display 8, for training purposes. The application may also provide programs to store, track and manipulate impact and training related data.

The present devices and systems can be applied to any number of applications and as would be conceivable by a skilled person in the art. For example and by way of illustration only, it is possible to apply the present devices and systems to boxing headgear, boxing ropes, corner ring that lights up, baseball, baseball bat, baseball bases, just to name a few.

The devices and systems of the present invention can also be applied to quick reflex and impact related games in which targets are struck to the beat of music or to the beat of flashing colours or lights. Rhythm related training games for boxing or mixed martial arts (MMA) are other examples of applications of the present devices and systems.

In yoga mats and different types of therapy or rehabilitation mats or the present devices and systems can provide information on pressure points.

The previous description of the disclosed embodiments is provided to enable any person skilled in the art to make or use the present disclosure. Various modifications to those embodiments will be readily apparent to those skilled in the art, and the generic principles defined herein may be applied to other embodiments without departing from the spirit or scope of the disclosure. Thus, the present disclosure is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A kinetic sensing device comprising:
a) one or more sensor units, each sensor unit comprising one or more interactive light displays and one or more sensors in the form of voltage generating materials affixed under each interactive light display;
b) a micro-controller for processing data from the one or more sensors;
c) a transmitter for transmitting processed data from the micro-controller; and
d) a power source for charging the sensors, powering the micro-controller and powering the transmitter,
wherein the sensors can detect and distinctly process each kinetic force reading and be set to zero to ready to process a next impact, in the absence of any capacitor.

2. The kinetic sensing device of claim 1, wherein the micro-controller further serves to provide interactive controls and functions to program the interactive light display for training purposes.

3. The kinetic sensing device of claim 1, wherein the voltage generating materials of the one or sensors is selected from the group consisting of piezo-electric materials and carbon nano-tube materials.

4. The kinetic sensing device of claim 1, wherein the one or more sensor unit are connectable to one another to form a modular system,

5. The kinetic sensing device of claim 4, wherein the modular system further comprises a connection hub in the form of an attachable, not non-sensory element that serves to connect wiring between the one or more sensor units of and modular system and the microcontroller.

6. The kinetic sensing device of claim 1, wherein the one or more sensing units are made of flexible materials.

7. The kinetic sensing device of claim 6, wherein the sensing units are printed on flexible printed circuits (FPC).

8. The kinetic sensing device of claim 1, wherein microcontroller is internal to each of the one or more sensing units.

9. The kinetic sensing device of claim 1 wherein the micro-controller is external to the one or more sensing units and connected thereto by a flexible flat cable (FFC).

10. The kinetic sensing device of claim 1, wherein the flexible interactive light display layer incorporates a flexible electroluminescent light.

11. The kinetic sensing device of claim 1, further comprising a partially yielding layer over the interactive display layer.

12. The kinetic sensing device of claim 1, further comprising an attachable backing attachable to and removable from equipment.

13. The kinetic sensing device of claim 1, wherein the microcontroller, power source, and transmitter are housed in a micro-controller unit.

14. The kinetic sensing device of claim 13, further comprising one or more relays in the micro-controller unit to control signals coming from one or more of the one or more sensor units.

15. A method of sensing, processing and transmitting kinetic force data, said method comprising the steps of:
a) charging a sensor in the form of a voltage generating material, causing molecules in the voltage generating material to contract and simultaneously starting a cycle count;
b) performing a count of the oscillations before a charge or discharge has passed;
c) detecting a kinetic force;
d) discharging the sensor;
e) readying the sensor for a next kinetic force reading or interpretation; and
f) rapidly cycling back to step a),
wherein the method is performed in the absence of any capacitors.

16. The method of claim 15, where a cycle of recorded time is equivalent to a particular force of impact.

17. The method of claim 16, readying the sensor for the next kinetic force reading comprises clearing the sensor of any original force data and of any charge going through the sensor.

18. The method of claim 17 further comprising a step of wirelessly transmitting kinetic force data sensed by the sensor to a smart device for displaying, storing and tracking the kinetic force data.

19. The method of claim 18, wherein location data related to the kinetic force data is also transmitted wirelessly to the smart device.

20. A method of readying a system to process_kinetic force data, said method comprising the steps of:
a) charging a sensor in the form of a voltage generating material, causing molecules in the voltage generating material to contract and simultaneously starting a cycle count;
b) performing a count of the oscillations before a charge or discharge has passed;
c) discharging the sensor;
d) readying the sensor for a next kinetic force reading or interpretation; and
e) rapidly cycling back to step a).
